(19) United States
(12) Patent Application Publication
(10) Pub. No.: US 2011/0041129 A1
(43) Pub. Date: Feb. 17, 2011

(54) PROCESS MANAGEMENT APPARATUS, TERMINAL APPARATUS, PROCESS MANAGEMENT SYSTEM, COMPUTER READABLE MEDIUM AND PROCESS MANAGEMENT METHOD

(75) Inventor: Takashi SAKAMOTO, Ebina-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI XEROX CO., LTD., Tokyo (JP)

(21) Appl. No.: 12/719,380

(22) Filed: Mar. 8, 2010

(30) Foreign Application Priority Data
Aug. 13, 2009 (JP) 2009-187669

(51) Int. Cl. G06F 9/46; G06F 15/16

(52) U.S. Cl. 718/100; 709/201

(57) ABSTRACT

A process management apparatus includes a receiving unit and a processing unit. The receiving unit receives identification information read by plural readers corresponding to plural terminal apparatuses when a medium is received, a first notification notifying that processing in a process where the identification information is read is completed, and a second notification notifying that the medium is received from a preceding process, from the plural terminal apparatuses. The processing unit executes predetermined processing, when the identification information and the second notification are not received from a terminal apparatus of a next process, within a predetermined time period after the first notification is received.

### CROSS-REFERENCE TO RELATED APPLICATIONS

This application is based on and claims priority under 35 USC 119 from Japanese Patent Application No. 2009-187669 filed Aug. 13, 2009.

### BACKGROUND

### Technical Field

The invention relates to a process management apparatus, a terminal apparatus, a process management system, a computer readable medium storing a process management program, and a process management method.

### SUMMARY

According to an aspect of the invention, there is provided a process management apparatus including: a receiving unit that receives identification information, a first notification, and a second notification from each of a plurality of terminal apparatuses, the plurality of terminal apparatuses being provided to correspond to a plurality of processes to sequentially receive a medium assigned with the identification information and to process the medium, the identification information being read by each of a plurality of readers provided to correspond to the plurality of processes when the medium is received, the first notification notifying that processing in a process where the identification information is read is completed, the second notification notifying that the medium is received from a preceding process; and a processing unit that executes predetermined processing, when the identification information read by a reader provided to correspond to a next process of an arbitrary process of the plurality of processes and the second notification are not received from a terminal apparatus provided to correspond to the next process, within a predetermined time period after the identification information read by a reader provided to correspond to the arbitrary process and the first notification are received from a terminal apparatus provided to correspond to the arbitrary process.

### BRIEF DESCRIPTION OF THE DRAWINGS

Exemplary embodiments of the present invention will be described in detail based on the following figures, wherein:

FIG. 1 is a diagram illustrating a configuration of a process management system according to first to third exemplary embodiments;

FIG. 2 is a diagram illustrating a configuration of a management server according to the first to third exemplary embodiments;

FIG. 3 is a diagram illustrating a configuration of a terminal apparatus according to the first to third exemplary embodiments;

FIG. 4 is a diagram illustrating a configuration of a reader according to the first to third exemplary embodiments;

FIG. 5 is a diagram illustrating a configuration of an IC tag according to the first to third exemplary embodiments;

FIG. 6 is a flowchart illustrating a process routine that is executed by the terminal apparatus according to the first to third exemplary embodiments;

FIG. 7 is a flowchart illustrating a process routine that is executed by the management server according to the first exemplary embodiment;

FIG. 8 is a schematic and simplified view illustrating a process flow described using FIGS. 6 and 7;

FIG. 9 is a flowchart illustrating a process routine that is executed by the management server according to the second exemplary embodiment;

FIG. 10 is a flowchart illustrating a process routine that is executed by the management server according to the third exemplary embodiment; and

FIG. 11 is a flowchart illustrating a process routine that is executed by the management server according to the third exemplary embodiment.

### DETAILED DESCRIPTION

Hereinafter, various exemplary embodiments of the invention will be described in detail with reference to the accompanying drawings.

### First Exemplary Embodiment

In the first exemplary embodiment, a process management system that manages a processing status in plural processes for sequentially receiving processing target medium and processing the medium will be described.

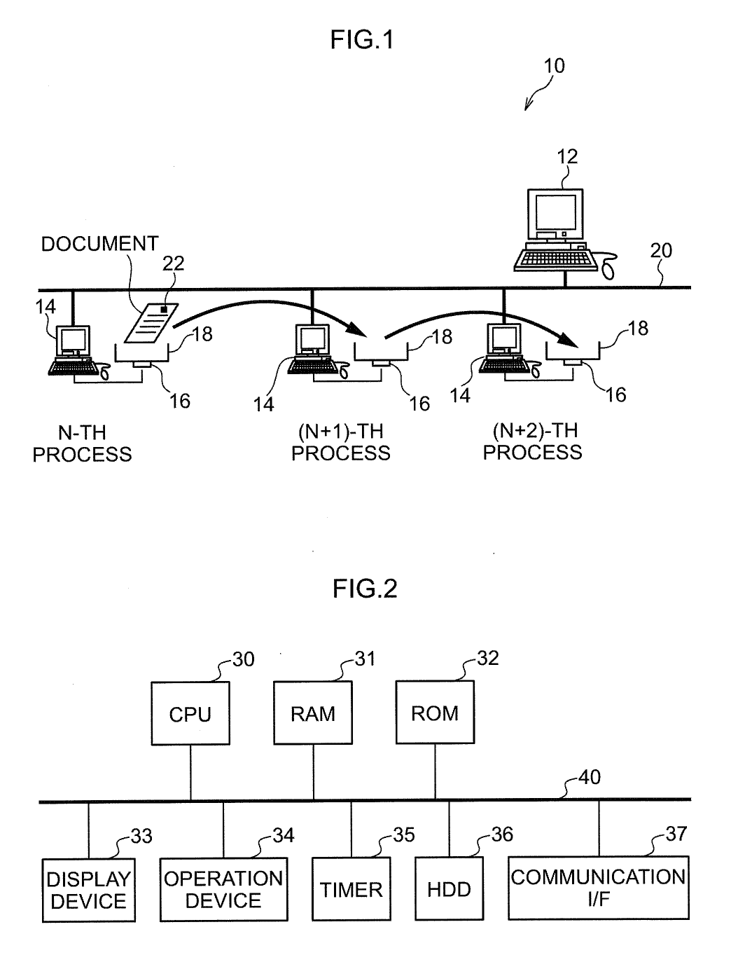

FIG. 1 illustrates a configuration of a process management system 10 according to the first exemplary embodiment.

The process management system 10 includes a management server 12 and plural terminal apparatuses 14. The management server 12 and the terminal apparatuses 14 are connected to a network 20.

The plural terminal apparatuses 14 are provided to correspond to the plural processes. A document storage unit 18 that stores a processing target document is provided to correspond to each of the terminal apparatuses 14 (that is, to correspond to each of the processes). The processing target document is provided with an IC tag 22, and the IC tag 22 stores identification information (hereinafter, referred to as an ID) to identify each document. The document storage unit 18 is provided with a reader 16 that reads an ID from the IC tag 22 provided in the document. The reader 16 is electrically connected to the terminal apparatus 14. The reader 16 (it may be called the document storage unit 18 where the reader 16 is provided) is disposed in a predetermined distance from the corresponding terminal apparatus 14.

The terminal apparatus 14 transmits the ID that is read by the reader 16 provided to correspond to the terminal apparatus 14, and a process completion notification (to be described in detail below) or a reception notification (to be described in detail below) to the management server 12. The management server 12 receives the process completion notification and/or the reception notification from the terminal apparatus 14. Based on the received notification, the management server 12 manages a processing status of each process, such that the processing target document is being processed at the present time at which process, to which process the processes are completed, and the process completion time when each process is completed, or confirms whether the processing target document is received in a next process after processing in an arbitrary process ends, according to a process routine to be described below.

In the first exemplary embodiment, if processing that each person (operator, clerk) is in charge ends, each person who executes processing with respect to the processing target document in each process stores the processing target document in the document storage unit 18 provided to correspond to a next process. Thereby, the processing target document moves between the individual processes. A document delivery method is not limited to the above example. For example, when each person in charge receives the processing target document from the person in charge of the preceding process, each person receiving the target document may store the received document in the document storage unit 18 for the corresponding process. In either cases, the ID is read from the IC tag 22 of the document stored in the document storage unit 18 by the reader 16 that is provided in the document storage unit 18 of each process.

FIG. 2 illustrates a configuration of the management server 12.

The management server 12 includes a central processing unit (CPU) 30, a random access memory (RAM) 31, a read only memory (ROM) 32, a display device 33, an operation device 34, a timer 35, a hard disk drive (HDD) 36, and a communication interface (I/F) 37. These components are respectively connected to a bus 40.

The CPU 30 executes a program (including a program of a process routine to be described in detail below) that is stored in the ROM 32 or the HDD 36, and controls the whole operation of the management server 12. The ROM 32 stores the program that is executed by the CPU 30 or data that is necessary for the processing of the CPU 30. The RAM 31 is used as a work memory.

A storage medium that stores the program executed by the CPU 30 is not limited to the HDD 36 or the ROM 32. For example, the storage medium may be a flexible disk, a DVD disk, a magneto-optical disk or a USB memory (not illustrated). Alternatively, the storage medium may be a storage device of another apparatus that is connected to the network 20.

The display device 33 is composed of a liquid crystal display for example, and displays various images or messages under the control of the CPU 30.

The operation device 34 is composed of a keyboard or a mouse for example, and a variety of information is input when a user operates the operation device 34.

The timer 35 is used to clock a time (hereinafter, also referred to as document movement time) from a process completion notification which indicates that processing of the target document is completed and the ID are received at an arbitrary process (N) until a reception notification which indicates that processing of the target document and the ID are received at a next process (N+1).

The HDD 36 stores the program executed by the CPU 30 or the variety of data. Process information that indicates contents, sequences, and process completion time limits of the individual processes to be managed and a timeout time are stored by being associated with ID.

The timeout time is a threshold value that is used to detect a timeout of the document movement time between the individual processes. As the timeout time, a timeout time that is common to the individual processes may be stored. Alternatively, as the timeout time, each timeout time of the individual processes may be stored. In the first exemplary embodiment, it is assumed that the timeout times of the individual processes are stored.

The HDD 36 also stores information (management information) which indicates a processing status of each process, for example, information that the processing target document is being processed at the present time at which process, to which process the processes are completed, and the process completion time when each process is completed. The management information is added and updated according to the processing status (for example, according to the completion notification and/or the reception notification).

A storage unit that stores the process information, the timeout time, and the management information is not limited to the HDD 36. For example, the storage unit may be the ROM 32, a flexible disk, a magneto-optical disk or a USB memory (not illustrated), or a storage device of another storage apparatus that is connected to the network 20.

The communication I/F 37 is an interface that is used to exchange data with another apparatus through the network 20.

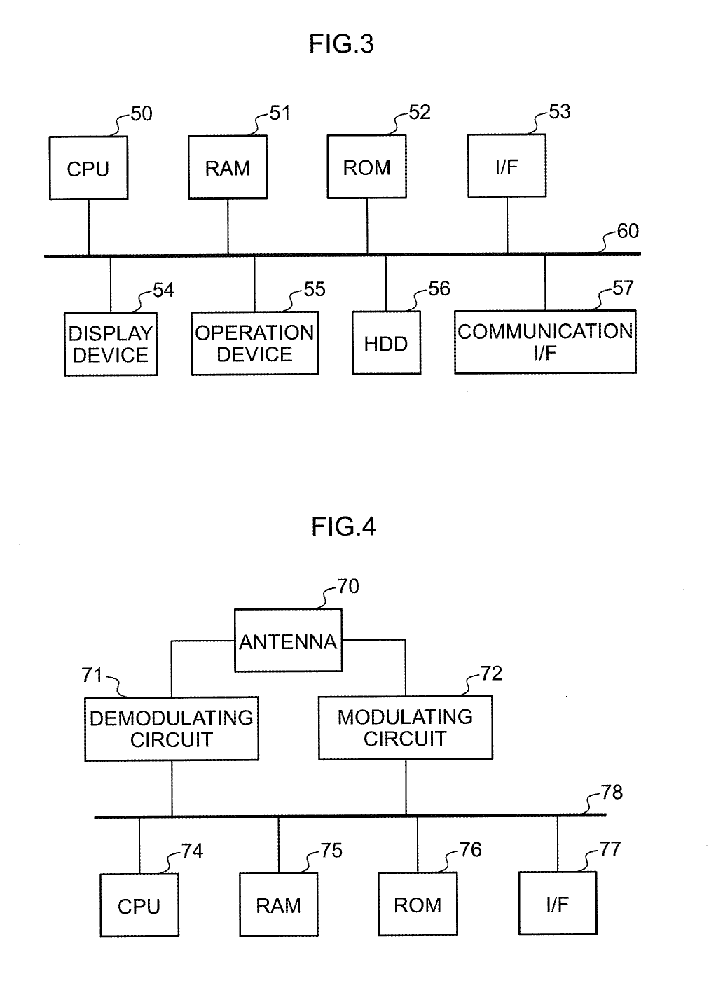

FIG. 3 illustrates a configuration of the terminal apparatus 14.

The terminal apparatus 14 includes a central processing unit (CPU) 50, a random access memory (RAM) 51, a read only memory (ROM) 52, an interface (I/F) 53, a display device 54, an operation device 55, an HDD 56, and a communication interface (I/F) 57. These components are connected to a bus 60.

The CPU 50 executes a program (including a program of a process routine to be described in detail below) that is stored in the ROM 52 or the HDD 56, and controls the whole operation of the terminal apparatus 14. The ROM 52 stores the program that is executed by the CPU 50 or data that is necessary for the processing of the CPU 50. The RAM 51 is used as a work memory.

A storage medium that stores the program executed by the CPU 50 is not limited to the HDD 56 or the ROM 52. For example, the storage medium may be a flexible disk, a DVD disk, a magneto-optical disk or a USB memory (not illustrated). Alternatively, the storage medium may be a storage device of another storage apparatus that is connected to the network 20.

The I/F 53 is an interface that is used to connect the terminal apparatus 14 to the reader 16. The ID that is stored in the IC tag 22 provided in the document stored in the document storage unit 18 is read by the reader 16 provided in the document storage unit 18. The ID is transmitted from the reader 16 to the terminal apparatus 14 through the I/F 53. The ID is stored in the storage device such as the HDD 56.

The display device 54 is composed of a liquid crystal display for example, and displays various images or messages under the control of the CPU 50.

The operation device 55 is composed of a keyboard or a mouse for example, and a variety of information and/or a variety of instructions are input when a user operates the operation device 55. A transmission instruction that instructs to transmit the above-described process completion notification is also input through the operation device 55.

The HDD 56 stores the program executed by the CPU 50 or the variety of data.

The communication I/F 57 is an interface that is used to exchange data with another apparatus through the network 20.

FIG. 4 illustrates a configuration of the reader 16.

The reader 16 includes an antenna 70 that is used to communicate with the IC tag 22 in a non-contact method. The reader 16 further includes a demodulating circuit 71, a modulating circuit 72, a central processing unit (CPU) 74, a random access memory (RAM) 75, a read only memory (ROM) 76, and an interface (I/F) 77. These components are respectively connected to a bus 78.

The demodulating circuit 71 is a circuit that demodulates data received from the antenna 70.

The modulating circuit 72 is a circuit that modulates the data read from the RAM 75 and/or the ROM 76.

The CPU 74 executes a program stored in the ROM 76 and controls the whole operation of the reader 16. The ROM 76 stores the program that is executed by the CPU 74 or data that is necessary for the processing of the CPU 74. The RAM 75 is used as a work memory.

The I/F 77 is an interface that connects the reader 16 to the terminal apparatus 14. The I/F 77 of the reader 16 and the I/F 53 of the terminal apparatus 14 may be interfaces that are used to perform communication in a non-contact method.

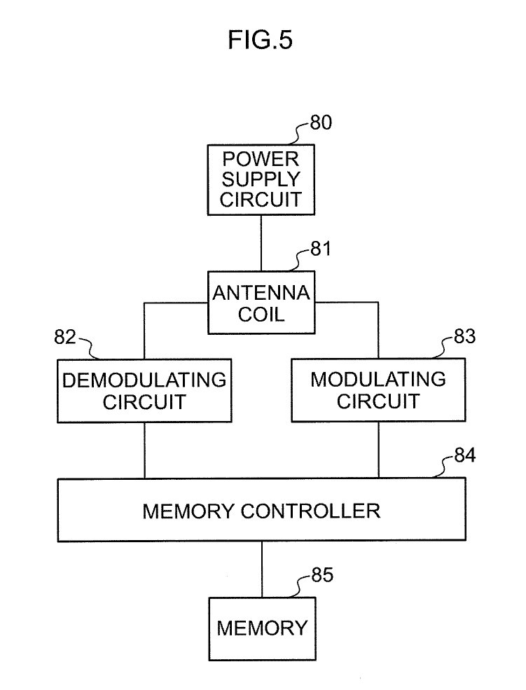

FIG. 5 illustrates a configuration of the IC tag 22.

The IC tag 22 includes a power supply circuit 80, an antenna coil 81, a demodulating circuit 82, a modulating circuit 83, a memory controller 84, and a memory 85.

The antenna coil 81 that is an antenna used to communicate with the reader 16 in a non-contact method receives radio waves and generates power. Although not illustrated in the drawings, the IC tag 22 is provided with a capacitor that is charged by an electromotive force induced to the antenna coil 81.

The power supply circuit 80 supplies driving power to each unit of the IC tag 22, based on the charge accumulated in the capacitor.

The demodulating circuit 82 is a circuit that demodulates the data received from the antenna coil 81.

The modulating circuit 83 is a circuit that modulates the data read from the memory 85 by the memory controller 84.

The memory controller 84 controls read/write of data on the memory 85. The memory 85 stores an ID that is assigned to the document provided with the IC tag 22 in advance.

As the memory 85, a non-volatile memory such as an EEPROM or a flash memory is used. Thereby, even when power is not supplied to the memory 85, recorded data is held.

A non-contact communication that is performed between the reader 16 and the IC tag 22 will be described. Under the control of the CPU 74 of the reader 16, radio waves that generate an electromotive force in the antenna coil 81 of the IC tag 22 are transmitted from the reader 16 at a predetermined time interval. In addition, a request signal that requests to transmit the ID stored in the memory 85 of the IC tag 22 is modulated by the modulating circuit 72 and transmitted from the reader 16.

If the radio waves that are transmitted from the reader 16 are received by the antenna coil 81 of the IC tag 22, the electromotive force is generated in the antenna coil 81, the capacitor is charged, and power is supplied to each unit through the power supply circuit 80. In addition, if the request signal is received by the antenna coil 81, the request signal is demodulated by the demodulating circuit 82 and transmitted to the memory controller 84. The memory controller 84 receives the request signal, reads the ID that is stored in the memory 85, modulates the ID by the modulating circuit 83, and transmits the ID through the antenna coil 81.

In the reader 16, the ID that is transmitted from the IC tag 22 is received through the antenna 70 and is demodulated by the demodulating circuit 71. The demodulated ID is transmitted to the terminal apparatus 14 through the I/F 77.

If the IC tag 22 does not exist in a range where the radio waves of the reader 16 and/or the request signal reaches, a read failure notification as a read result is transmitted to the terminal apparatus 14.

The function of the process management system 10 according to the first exemplary embodiment will be described.

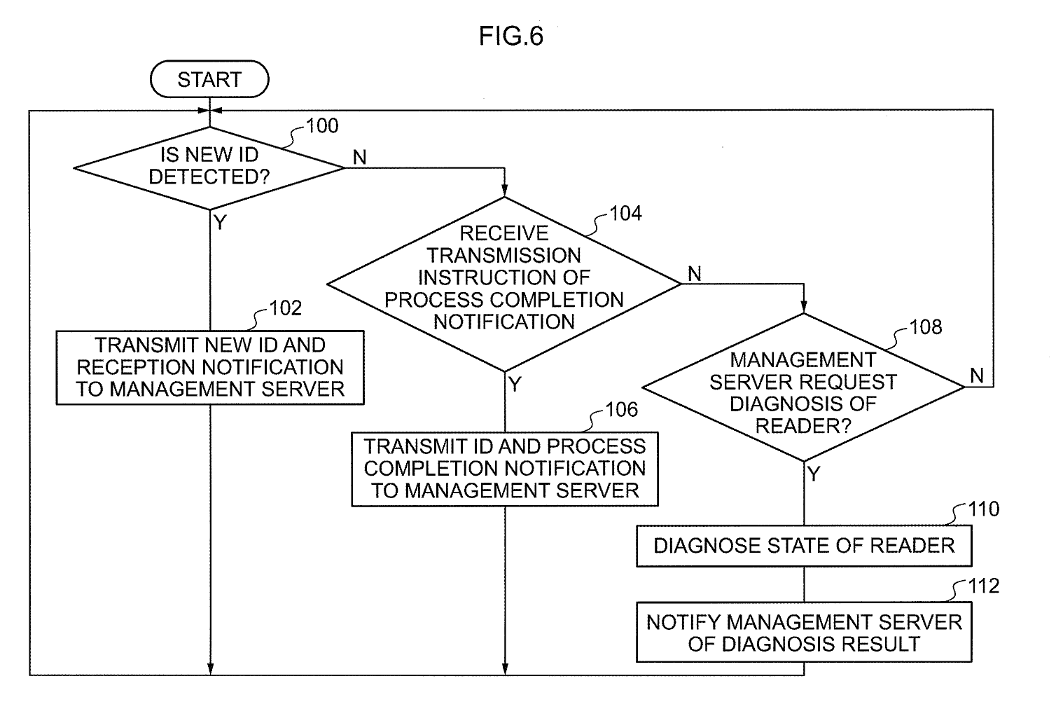

FIG. 6 is a flowchart illustrating the process routine that is executed by the terminal apparatus 14.

In step 100, it is determined whether a new ID is detected. As described above, the reader 16 performs a read operation at a predetermined time interval and transmits a read result to the terminal apparatus 14. In the terminal apparatus 14, it is confirmed whether the ID is included in the read result and is the same as an ID stored in the HDD 56. When the ID is not included in the read result or the ID is included in the read result and the ID is the same as the ID stored in the HDD 56, the determination result of step 100 is negative (NO). When the ID is included in the read result and the ID is not an ID stored in the HDD 56, the determination result of step 100 is affirmative (YES).

When the determination result of step 100 is affirmative, the newly detected ID and a reception notification are transmitted to the management server 12, in step 102. The newly detected ID is stored in the HDD 36.

When the determination result of step 100 is negative, the process routine proceeds to step 104. In step 104, it is determined whether a transmission instruction of the process completion notification is received from the person in charge through the operation device 55. When it is determined that the transmission instruction of the process completion notification is received from the person in charge, the ID of the processed document and the process completion notification are transmitted to the management server 12, in step 106. In step 104, when it is determined that the transmission instruction of the process completion notification is not received from the person in charge, the process routine proceeds to step 108.

In step 108, it is determined whether a diagnosis request which requests to diagnose of a state of the reader 16 is received from the management server 12. When it is determined in step 108 that the diagnosis request is received, diagnosis processing to diagnose of the state of the corresponding reader 16 is executed, in step 110. In step 112, a diagnosis result of the reader 16 is transmitted to the management server 12. When it is determined in step 108 that the diagnosis request is not received, the process routine returns to step 100.

A specific example of the diagnosis processing to diagnose of the state of the reader 16 will be described.

For example, an instruction that instructs to perform the read operation is transmitted from the terminal apparatus 14 to the reader 16 through the I/F 53. Then, when the terminal apparatus 14 normally (without an error) receives the read result (for example, the ID or the read failure notification) from the reader 16, the terminal apparatus 16 diagnoses that the state of the reader 16 is normal. Otherwise, when the read result is not normally received, the terminal apparatus 14 diagnoses that abnormality has occurred in the reader 16.

When the reader 16 has a self-diagnosis function, this function may be used. For example, an execution command of the self-diagnosis function is transmitted from the terminal apparatus 14 to the reader 16 to cause the reader 16 to execute the self diagnosis, and the diagnosis result is transmitted.

A self-diagnosis method is not limited in particular. For example, the following method may be used. A predetermined signal is transmitted from the CPU 74 of the reader 16 to the individual components constituting the reader 16. At this time, when the individual components are not normally operated according to the predetermined signal, it is diagnosed that an abnormality has occurred in the reader 16. A circuit that executes the self diagnosis may be separately provided in the reader 16 (not illustrated in FIG. 4), a diagnosis signal may be transmitted from the circuit to the other components of the reader 16, and the circuit may acquire an output value with respect to the diagnosis signal. Then, the circuit may compare the output value and a predetermined expectation value and diagnose of the state of the reader 16.

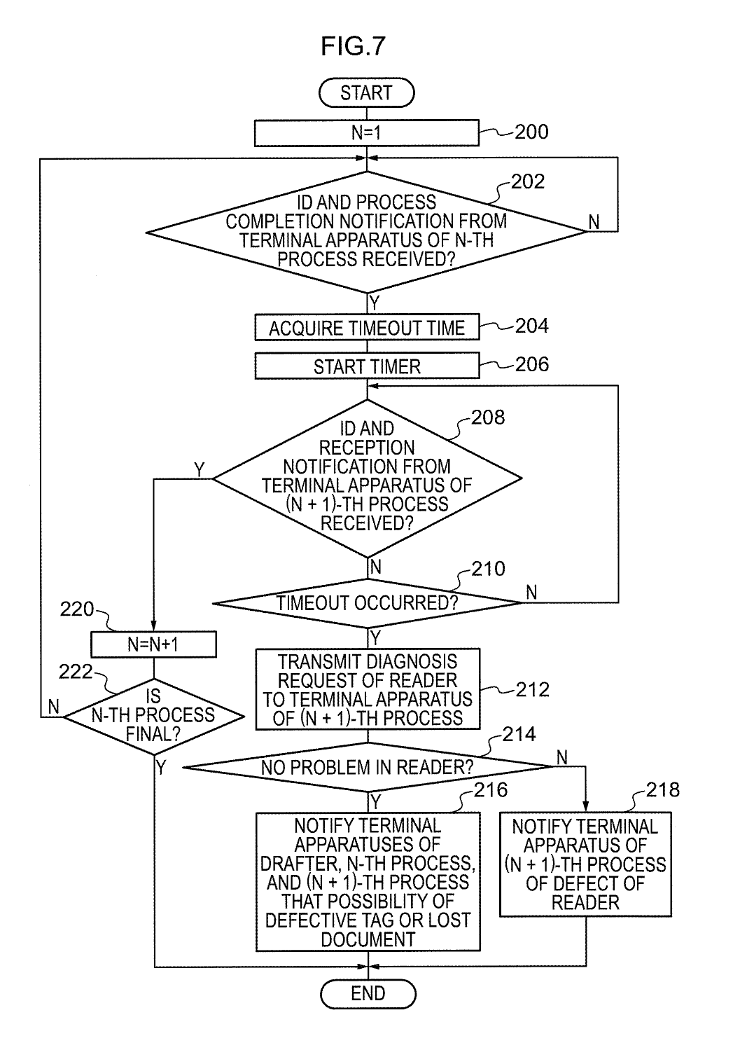

FIG. 7 is a flowchart illustrating the process routine that is executed by the management server 12. If the management server 12 accepts by receiving the process completion notification or the reception notification, the management server 12 updates management information. In the description below, the update of the management information is not described.

In step 200, 1 is set to N.

In step 202, it is determined whether the ID of the document and the process completion notification are received (received and accepted) from the terminal apparatus 14 provided to correspond to the N-th process. When the determination result of step 202 is affirmative, the process routine proceeds to step 204.

In step 204, a timeout time, which is used to detect a timeout of a document movement time from the ID and the process completion notification are received from the terminal apparatus 14 provided to correspond to the N-th process until an ID and a reception notification are received from the terminal apparatus 14 provided to correspond to the (N+1)-th process, is read from the HDD 36 and the timeout time is acquired.

In step 206, the timer 35 starts and a clock operation starts.

In step 208, it is determined whether the ID (which is the same as the ID received along with the process completion notification of the N-th process) and the reception notification are received from the terminal apparatus 14 provided to correspond to the (N+1)-th process. When the determination result of step 208 is negative, it is determined whether the clocked time of the timer 35 exceeds the timeout time acquired in step 204, in step 210. When the determination result of step 210 is negative, the process routine returns to step 208. When the determination result of step 210 is affirmative, the clocking operation of the timer 35 is stopped and the process routine proceeds to step 212.

In step 212, a diagnosis request of the reader 16 is transmitted to the terminal apparatus 14 provided to correspond to the (N+1)-th process. Thereby, as described above, in the terminal apparatus 14, the diagnosis processing of the reader 16 is executed in step 110 and the diagnosis result of reader 16 is transmitted in step 112.

In step 214, the diagnosis result of the reader 16 that is received from the terminal apparatus 14 provided to correspond to the (N+1)-th process is confirmed. When the diagnosis result of the reader 16 indicates that the reader 16 is normal (the reader 16 has no problem), in step 216, a notification indicating that there is a possibility that an abnormality other than an abnormality of the reader 16 corresponding to the (N+1)-th process has occurred (for example, the IC tag 22 provided in the document is defective or the document is lost) is transmitted to each of the terminal apparatus 14 (that is, terminal apparatus 14 provided to correspond to the first process) of a drafter who is the person in charge of the first process and instructs to execute a series of processing in the plural processes with respect to the document assigned with the ID, the terminal apparatus 14 provided to correspond to the N-th process, and the terminal apparatus 14 provided to correspond to the (N+1)-th process. In the case of N=1, since the terminal apparatus 14 that is provided to correspond to the first process is the same as the terminal apparatus 14 that is provided to correspond to the N-th process, the notification is transmitted to each of the terminal apparatus 14 provided to correspond to the N-th (the first) process and the terminal apparatus 14 provided to correspond to the (N+1)-th (the second) process. The terminal apparatus 14 that receives the notification displays the contents of the notification on the display device 54.

In step 214, when the diagnosis result of the reader 16 that is received from the terminal apparatus 14 provided to correspond to the (N+1)-th process indicates that an abnormality has occurred in the reader 16, the defect of the reader 16 is notified to the terminal apparatus 14 that is provided to correspond to the (N+1)-th process, in step 218. The terminal apparatus 14 that receives the notification displays the contents of the notification on the display device 54.

When the determination result of step 208 is affirmative, the clocking operation of timer 35 is stopped and the process routine proceeds to step 220. In step 220, 1 is added to N. In step 222, it is determined whether the N-th process is the final process. When it is determined that the N-th process is the final process, the process routine ends, and when it is determined that the N-th process is not the final process, the process routine returns to step 202.

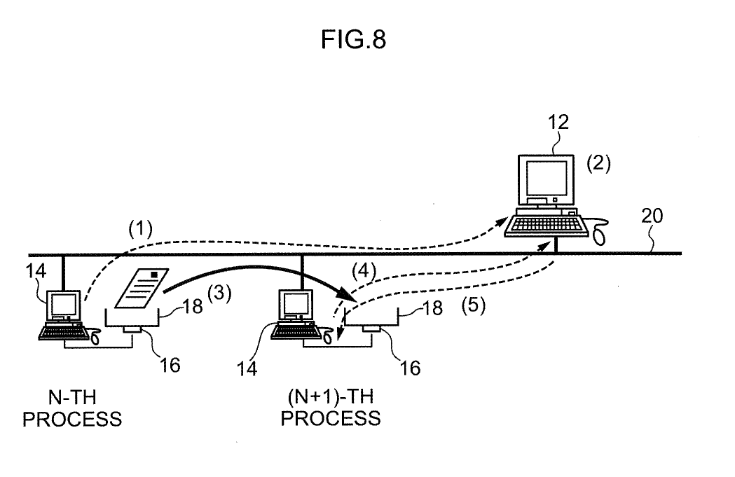

FIG. 8 is a schematic and simplified view illustrating a process flow described using FIGS. 6 and 7.

In a part (1), if the processing of the N-th process is completed, the terminal apparatus 14 that is provided to correspond to the N-th process transmits the ID read by the reader 16 when receiving the document and the process completion notification.

In a part (2), if the management server 12 receives the ID and the process completion notification from the terminal apparatus 14 provided to correspond to the N-th process, the management server 12 starts the timer 35 and starts a clock operation.

In a part (3), the person in charge of the N-th process stores the processing target document in the document storage unit 18 of the next process ((N+1)-th process). Alternatively, the person in charge of the N-th process may deliver the processing target document to the person in charge of the (N+1)-th process and the person in charge of the (N+1)-th process may store the processing target document in the corresponding document storage unit 18.

In a part (4), the terminal apparatus 14 that is provided to correspond to the (N+1)-th process transmits an ID newly read by the reader 16 of the document storage unit 18 of the (N+1)-th process along with a reception notification to the management server 12.

In the part (4), when the timeout is generated before the management server 12 receives the ID and the reception notification. The management server 12 transmits a diagnosis request of the reader 16 to the terminal apparatus 14 provided to correspond to the (N+1)-th process, in a part (5). The terminal apparatus 14 that is provided to correspond to the (N+1)-th process receives the diagnosis request, diagnoses of the reader 16, and returns the diagnosis result to the management server 12. The management server 12 executes processing according to the diagnosis result.

Since the reception notification with respect to the first process is not transmitted, instead of the reception notification, a start notification that is a notification to start a series of work through the plural processes and the ID read by the reader 16 may be transmitted to the management server 12. The drafter that is the person in charge of the first process reads the ID using the reader 16 and instructs the terminal apparatus 14 to transmit the start notification. When the terminal apparatus 14 receives the instruction, the start notification is transmitted from the terminal apparatus 14.

In the first exemplary embodiment, the case where the information of the timeout time is previously stored in the HDD 36 is described, but the invention is not limited thereto. For example, the person in charge of the N-th process may dynamically designate the timeout time with respect to the document movement time from the N-th process to the (N+1)-th process. In this case, the information of the timeout time that is designated by the person in charge of the N-th process along with the process completion notification may be transmitted from the terminal apparatus 14 to the management server 12.

The drafter may previously designate the timeout time with respect to the document movement time between the individual processes.

The management server 12 may determine the timeout time with respect to the document movement time between the individual processes, based on the disposition (installation site/location) of the reader 16 provided to correspond to each process (it may be called the disposition of the document storage unit 18 where the reader 16 is provided or the disposition of the terminal apparatus 14 in a predetermined distance from the reader 16). For example, the document movement time from an arbitrary process to a next process is determined in accordance with a distance (hereinafter, referred to as disposition distance) between the disposition of the terminal apparatus 14 that transmits a process completion notification of the arbitrary process and the disposition of the terminal apparatus 14 provided to correspond to the next process is considered since the movement speed when the document moves is constant (a variation in the movement speed is within a predetermined range). For example, as longer the disposition distance is, a longer timeout time may be set. Even when the movement speed varies between the individual processes, the timeout time may be determined from the movement time of the document such as a time obtained by dividing the disposition distance by the movement speed of the document.

The management server 12 may dynamically determine the timeout time from the processing status or the process information of each process. Specifically, from a date and time (or time) x when the N-th process completion notification is received and a time limit y included in the process information where processing of the (N+1)-th process necessary to be completed, a difference z of x and y may be calculated, and a time that is obtained by subtracting a processing time w expected as a time necessary to execute the processing in the (N+1)-th process from z may be obtained as the timeout time. The processing time w may be previously included in the process information and stored in the HDD 36, or may be obtained from a predetermined algorithm based on the processing contents of the individual processes.

The difference z may be determined as the timeout time. The timeout time may be determined according to the length of the processing time w (for example, the longer the processing time w is, the shorter the timeout time becomes).

The management sever 12 may determine the timeout time with respect to the document movement time between the individual processes, based on the processing status and the process information of each process and the disposition of the reader 16 provided to correspond to each process. For example, after the timeout time is obtained based on at least one of the x to z, the timeout time may be corrected based on the disposition of the reader 16 (it may be called the disposition of the document storage unit 18 where the reader 16 is provided or the disposition of the terminal apparatus 14 within the predetermined distance from the reader 16). Specifically, a correction value (for example, the longer the disposition distance is, the more the correction value increases) according to the disposition distance between the disposition of the terminal apparatus 14 that transmits the process completion notification and the disposition of the terminal apparatus 14 provided to correspond to the next process may be added to the obtained timeout time.

In the first exemplary embodiment, in step 216, the notification indicating that the possibility of the IC tag 22 provided in the document is defective or the document is lost is transmitted to each of the terminal apparatus 14 of the drafter, the terminal apparatus 14 provided to correspond to the N-th process (in the case of N is not 1), and the terminal apparatus 14 provided to correspond to the (N+1)-th process, but the invention is not limited thereto. The notification may be transmitted to at least one of the terminal apparatus 14 of the drafter, the terminal apparatus 14 provided to correspond to the N-th process (in the case of N is not 1), and the terminal apparatus 14 provided to correspond to the (N+1)-th process. Instead of the notification with respect to the terminal apparatus 14 or together with the notification, a character or an image indicating that an abnormality has occurred may be displayed on the display device 33 of the management server 12.

In the first exemplary embodiment, in step 218, the defect of the reader 16 is notified to the terminal apparatus 14 that is provided to correspond to the (N+1)-th process, but the invention is not limited thereto. The notification may be transmitted to at least one of the terminal apparatus 14 of the drafter, the terminal apparatus 14 provided to correspond to the N-th process (in the case of N is not 1), and the terminal apparatus 14 provided to correspond to the (N+1)-th process. Instead of the notification with respect to the terminal apparatus 14 or together with the notification, a character or an image indicating that an abnormality has occurred may be displayed on the display device 33 of the management server 12.

In the first exemplary embodiment, when the timeout is generated in step 210, the diagnosis request of the reader 16 is transmitted, but the invention is not limited thereto. For example, instead of the transmission of the diagnosis request of the reader 16, the notification of the occurrence of an abnormality (for example, the notification indicating that there is a possibility that an abnormality of any one of the defect of the reader 16 provided to correspond to the (N+1)-th process, the losing of the document, or the defect of the IC tag 22 being generated exists) may be transmitted to at least one of the terminal apparatus 14 of the drafter, the terminal apparatus 14 provided to correspond to the N-th process (in the case of N is not 1), and the terminal apparatus 14 provided to correspond to the (N+1)-th process. Alternatively, a character or an image indicating that an abnormality has occurred may be displayed on the display device 33 of the management server 12.

When the reception notification is received from the terminal apparatus 14 provided to correspond to the next process until the timeout is generated, if the next process is not the final process, the notification indicating that the movement of the document is normally made and the process normally proceeds to the next process may be transmitted to the terminal apparatus 14 of the drafter, or a character or an image indicating that the movement of the document is normally made and the process normally proceeds to the next process may be transmitted to the terminal apparatus 14 of the drafter may be displayed on the display device 33 of the management server 12.

### Second Exemplary Embodiment

In the second exemplary embodiment, a process management system that executes predetermined processing when a second notification is received before a first notification is received will be described.

A configuration of the process management system 10 according to the second exemplary embodiment is the same as the configuration of the process management system 10 according to the first exemplary embodiment, and a process routine that is executed by the terminal apparatus 14 is also the same as the process routine described using FIG. 6. Therefore, the description is omitted.

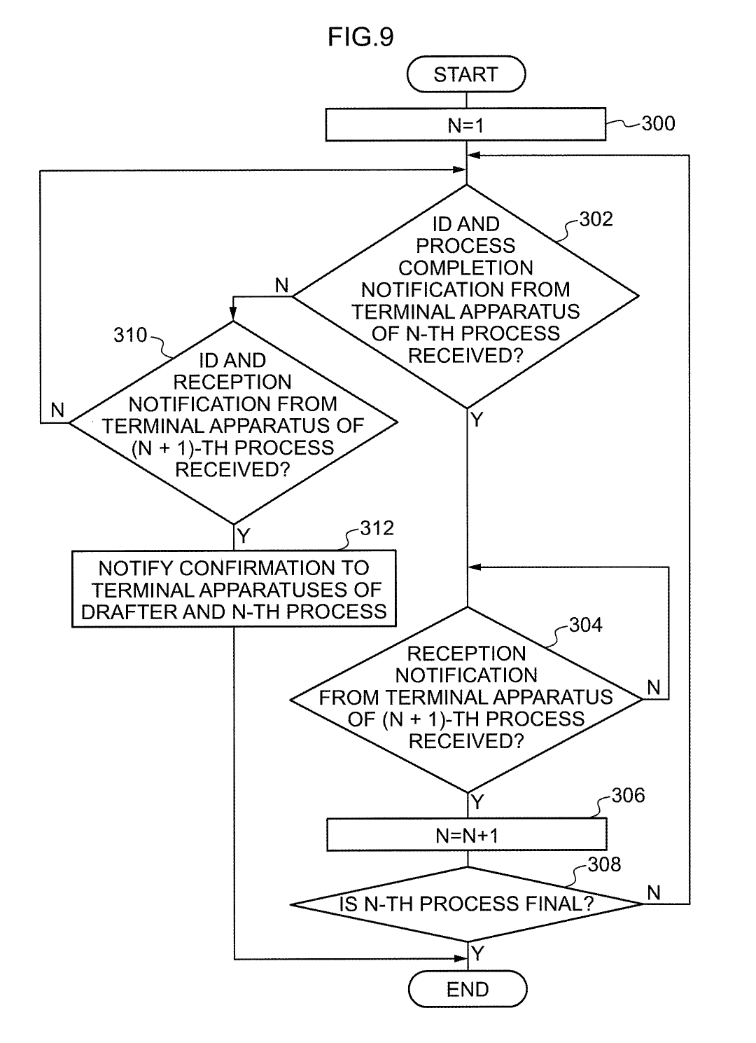

FIG. 9 is a flowchart illustrating a process routine that is executed by the management server 12 according to the second exemplary embodiment.

In step 300, 1 is set to N.

In step 302, it is determined whether the ID of the document and the process completion notification are received from the terminal apparatus 14 provided to correspond to the N-th process. When the determination result of step 302 is affirmative, the process routine proceeds to step 304.

In step 304, a waiting state is maintained until the ID of the document and the reception notification are received from the terminal apparatus 14 provided to correspond to the (N+1)-th process. If the ID and the reception notification are received from the terminal apparatus 14 provided to correspond to the (N+1)-th process, the process routine proceeds to step 306 and 1 is added to N. In step 308, it is determined whether the N-th process is the final process. When it is determined that the N-th process is the final process, this process routine ends, and when it is determined that the N-th process is not the final process, the process routine returns to step 302.

When the determination result of step 302 is negative, the process routine proceeds to step 310.

In step 310, it is determined whether the ID and the reception notification are received from the terminal apparatus 14 provided to correspond to the (N+1)-th process. When the determination result of step 310 is negative, the process routine returns to step 302. When the determination result of step 310 is affirmative, the reception notification of the (N+1)-th process is received before the process completion notification of the N-th process is received. Therefore, it is determined that the process proceeds to the (N+1)-th process before processing of the N-th process ends (processing of the N-th process is skipped) or an abnormality such as omission of the transmission instruction of the process completion notification has occurred, and the process routine proceeds to step 312.

In step 312, a confirmation notification that confirms the completion of the processing in the N-th process is transmitted to the terminal apparatuses 14 provided to correspond to the first and N-th processes, and the process routine ends. However, in the case of N is 1, since the terminal apparatus 14 that is provided to correspond to the first process is the same as the terminal apparatus 14 that is provided to correspond to the N-th process, the confirmation notification is transmitted to the terminal apparatus 14 provided to correspond to the N-th (the first) process. The terminal apparatus 14 that receives the confirmation notification displays the contents of the confirmation notification on the display device 54.

The processing in step 312 is an example and the invention is not limited thereto. For example, the confirmation notification may be transmitted to the terminal apparatus 14 provided to correspond to the (N+1)-th process. An instruction such as to interrupt the processing may be transmitted to the terminal apparatus 14 provided to correspond to the (N+1)-th process. After the confirmation notification is transmitted, when the process completion notification is received from the terminal apparatus 14 provided to correspond to the N-th process, a notification that requests to restart the interrupted processing may be transmitted to the terminal apparatus 14 provided to correspond to the (N+1)-th process or a notification indicating that the processing of the N-th process is normally completed may be transmitted to the terminal apparatus 14 of the drafter (the person in charge of the first process).

In the second exemplary embodiment, when the reception notification of the (N+1)-th process is received after the process completion notification of the N-th process is received, the process normally proceeds to the next process. Therefore, no process is executed (although not described above, the management information is updated), and the process routines returns to step 302. However, the invention is not limited thereto. For example, the notification indicating that the process normally proceeds to the next process may be transmitted to the terminal apparatus 14 of the drafter or a character or an image indicating that the process normally proceeds to the next process may be displayed on the display device 33 of the management server 12.

### Third Exemplary Embodiment

The management server 12 may execute a process routine that includes the aspects of the first exemplary embodiment and the second exemplary embodiment. Hereinafter, a flow of the process routine will be described in detail. A configuration of the process management system 10 according to the third exemplary embodiment is the same as the configuration of the process management system 10 according to the first exemplary embodiment, and a process routine that is executed by the terminal apparatus 14 is also the same as the process routine described using FIG. 6. Therefore, the description is omitted.

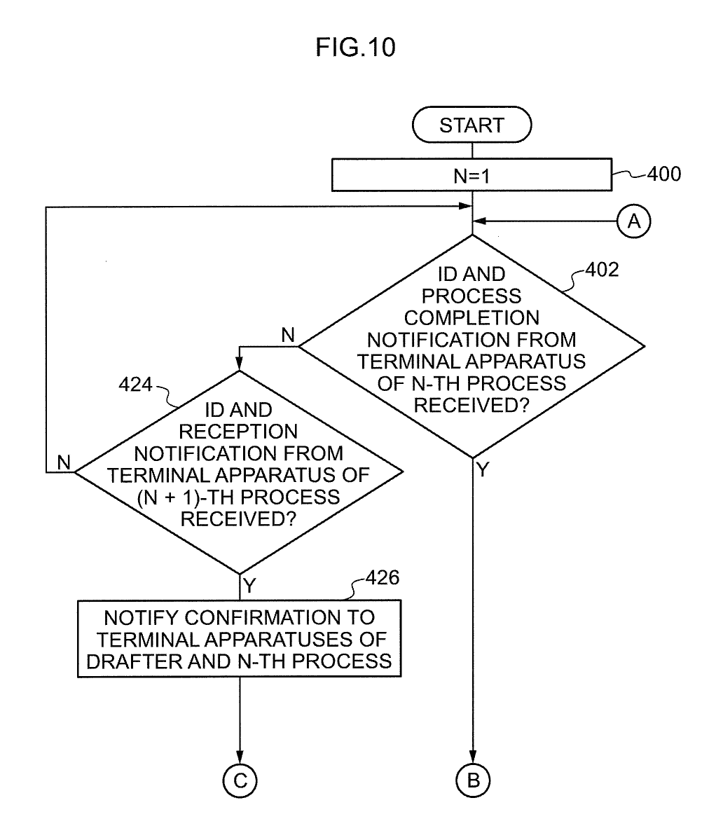

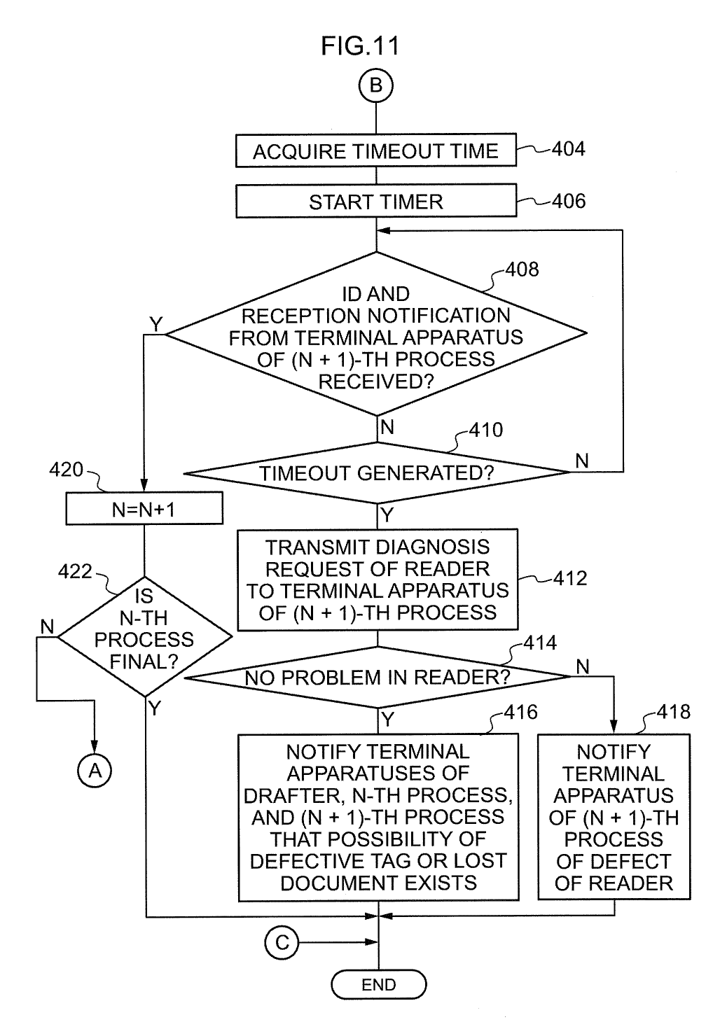

FIGS. 10 and 11 are flowcharts illustrating a process routine that is executed by the management server 12 according to the third exemplary embodiment.

In step 400, 1 is set to N.

In step 402, it is determined whether the ID of the document and the process completion notification are received from the terminal apparatus 14 provided to correspond to the N-th process. When the determination result of step 402 is affirmative, the process routine proceeds to step 404.

In step 404, the timeout time, which is used to detect the timeout of the document movement time from the time that the ID and the process completion notification are received from the terminal apparatus 14 provided to correspond to the N-th process until the time that the ID and the reception notification are received from the terminal apparatus 14 provided to correspond to the (N+1)-th process, is read from the HDD 36 and acquired.

In step 406, the timer 35 starts and an clock operation starts.

In step 408, it is determined whether the ID (which is the same as the ID received along with the process completion notification of the N-th process) and the reception notification are received from the terminal apparatus 14 provided to correspond to the (N+1)-th process. When the determination result of step 408 is negative, it is determined whether the clocked time of the timer 35 exceeds the timeout time acquired in step 404, in step 410. When the determination result of step 410 is negative, the process routine returns to step 408. When the determination result of step 410 is affirmative, the clocking operation of the timer 35 is stopped and the process routine proceeds to step 412.

In step 412, a diagnosis request of the reader 16 is transmitted to the terminal apparatus 14 provided to correspond to the (N+1)-th process.

In step 414, the diagnosis result of the reader 16 that is received from the terminal apparatus 14 provided to correspond to the (N+1)-th process is confirmed. When the diagnosis result of the reader 16 indicates that the reader 16 is normal (has no problem), in step 416, a notification indicating that there is a possibility that an abnormality other than an abnormality of the reader 16 has occurred (for example, the IC tag 22 provided in the document is defective or the document is lost) is transmitted to each of the terminal apparatus 14 of the drafter (that is, terminal apparatus 14 provided to correspond to the first process), the terminal apparatus 14 provided to correspond to the N-th process, and the terminal apparatus 14 provided to correspond to the (N+1)-th process. In the case of N is 1, since the terminal apparatus 14 that is provided to correspond to the first process is the same as the terminal apparatus 14 that is provided to correspond to the N-th process, the notification is transmitted to each of the terminal apparatus 14 provided to correspond to the N-th (the first) process and the terminal apparatus 14 provided to correspond to the (N+1)-th (the second) process. The terminal apparatus 14 that receives the notification displays the contents of the notification on the display device 54.

In step 414, when the diagnosis result of the reader 16 that is received from the terminal apparatus 14 provided to correspond to the (N+1)-th process indicates that an abnormality has occurred in the reader 16, a defect of the reader 16 is notified to the terminal apparatus 14 that is provided to correspond to the (N+1)-th process, in step 418. The terminal apparatus 14 that receives the notification displays the contents of the notification on the display device 54.

When the determination result of step 408 is affirmative, the clock operation of timer 35 is stopped and the process routine proceeds to step 420. In step 420, 1 is added to N. In step 422, it is determined whether the N-th process is the final process. When it is determined that the N-th process is the final process, the process routine ends, and when it is determined that the N-th process is not the final process, the process routine returns to step 402.

When the determination result of step 402 is negative, the process routine proceeds to step 424.

In step 424, it is determined whether the reception notification is received from the terminal apparatus 14 provided to correspond to the (N+1)-th process. When the determination result of step 424 is negative, the process routine returns to step 402. When the determination result of step 424 is affirmative, the reception notification of the (N+1)-th process is received before the process completion notification of the N-th process is received. Therefore, it is determined that processing of the N-th process is skipped or an abnormality such as omission of the transmission instruction of the process completion notification has occurred, and the process routine proceeds to step 426.

In step 426, a confirmation notification that confirms the completion of the processing in the N-th process is transmitted to the terminal apparatuses 14 provided to correspond to the first and N-th processes, and this process routine ends. In the case of N is 1, since the terminal apparatus 14 that is provided to correspond to the first process is the same as the terminal apparatus 14 that is provided to correspond to the N-th process, the confirmation notification is transmitted to the terminal apparatus 14 provided to correspond to the N-th (the first) process. The terminal apparatus 14 that receives the confirmation notification displays the contents of the confirmation notification on the display device 54.

In the first to third exemplary embodiments, the IC tag 22 where the ID is stored is provided in the processing target document and the ID is assigned to the document, but the invention is not limited thereto. For example, a barcode or a two-dimensional code indicating the ID may be printed on the document (or a printed material where the barcode or the two-dimensional code is printed may be added to the document), and the ID may be assigned to the document. In this case, a barcode reader or a two-dimensional code reader is used as the reader 16. In the case where the barcode or the two-dimensional code is used, when the barcode or the two-dimensional code may not be read by only storing the document in the document storage unit 18, the person in charge of each process causes the printed (or added) barcode or two-dimensional code to be placed in a readable range of the barcode reader or the two-dimensional code reader and reads the barcode or the two-dimensional code by the barcode reader or the two-dimensional code reader.

In the first to third exemplary embodiments, the processing target of the plural processes is the document, but the invention is not limited thereto. For example, the processing target may be a recording medium, such as a CD-RW or a USB memory, electronic paper. That is, the processing target may be an arbitrary medium.

The foregoing description of the embodiments of the present invention has been provided for the purpose of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to be suited to the particular use contemplated. It is intended that the scope of the invention be defined by the following claims and their equivalents.

What is claimed is:

1. A process management apparatus comprising:
a receiving unit that receives identification information, a first notification, and a second notification from each of a plurality of terminal apparatuses, the plurality of terminal apparatuses being provided to correspond to a plurality of processes to sequentially receive a medium assigned with the identification information and to process the medium, the identification information being read by each of a plurality of readers provided to correspond to the plurality of processes when the medium is received, the first notification notifying that processing in a process where the identification information is read is completed, the second notification notifying that the medium is received from a preceding process; and
a processing unit that executes predetermined processing, when the identification information read by a reader provided to correspond to a next process of an arbitrary process of the plurality of processes and the second notification are not received from a terminal apparatus provided to correspond to the next process, within a predetermined time period after the identification information read by a reader provided to correspond to the arbitrary process and the first notification are received from a terminal apparatus provided to correspond to the arbitrary process.

2. The process management apparatus of claim 1, wherein the processing unit executes processing for transmitting a diagnosis request, which requests to diagnose of whether the reader provided to correspond to the next process is normal, to the terminal apparatus provided to correspond to the next process, as the predetermined processing.

3. The process management apparatus of claim 2, wherein, when the diagnosis result of the reader executed with respect to the diagnosis request is normal and the arbitrary process is not a first process of the plurality of processes, the processing unit transmits a notification indicating that an abnormality other than an abnormality of the reader provided to correspond to the next process has occurred to at least one of a terminal apparatus provided to correspond to the first process, the terminal apparatus provided to correspond to the arbitrary process, or the terminal apparatus provided to correspond to the next process.

4. The process management apparatus of claim 2, wherein, when the diagnosis result of the reader executed with respect to the diagnosis request is normal and the arbitrary process is a first process of the plurality of processes, the processing unit transmits a notification indicating that an abnormality other than an abnormality of the reader provided to correspond to the next process has occurred to at least one of the terminal apparatus provided to correspond to the arbitrary process or the terminal apparatus provided to correspond to the next process.

5. The process management apparatus of claim 1, wherein the predetermined time period is determined based on at least one of a date and time or a time when the identification information and the first notification are received from the arbitrary process, a processing time necessary to process the next process, a time limit by which processing of the next process is to be completed, or a movement time of the medium according to a distance from a disposition of the reader corresponding to the arbitrary process to a disposition of the reader corresponding to the next process.

6. A process management apparatus, comprising:
a receiving unit that receives identification information, a first notification, and a second notification from each of a plurality of terminal apparatuses, the plurality of terminal apparatuses being provided to correspond to a plurality of processes to sequentially receive a medium assigned with the identification information and to process the medium, the identification information being read by each of a plurality of readers provided to correspond to the plurality of processes when the medium is received, the first notification notifying that processing in a process where the identification information is read is completed, the second notification notifying that the medium is received from a preceding process; and
a processing unit that executes predetermined processing, when the identification information read by a reader provided to correspond to a next process of an arbitrary process of the plurality of processes and the second notification are received from a terminal apparatus provided to correspond to the next process before the identification information read by a reader provided to correspond to the arbitrary process and the first notification are received from a terminal apparatus provided to correspond to the arbitrary process.

7. The process management apparatus of claim 6, wherein the processing unit executes processing for transmitting a confirmation notification, which indicates that a process proceeds to the next process before the arbitrary process ends, to at least one of a terminal apparatus provided to correspond to a first process, the terminal apparatus provided to correspond to the arbitrary process, or the terminal apparatus provided to correspond to the next process, when the arbitrary process is not the first process of the plurality of processes, as the predetermined processing.

8. The process management apparatus of claim 6, wherein the processing unit executes processing for transmitting a confirmation notification, which indicates that a process proceeds to the next process before the arbitrary process ends, to at least one of the terminal apparatus provided to correspond to the arbitrary process or the terminal apparatus provided to correspond to the next process, when the arbitrary process is the first process of the plurality of processes, as the predetermined processing.

9. A terminal apparatus that is provided to correspond to each of a plurality of processes to receive a medium assigned with identification information and process the medium, the terminal apparatus comprising:
a transmitting unit that transmits the identification information read by each of a plurality of readers provided to correspond to the plurality of processes when the medium is received, a first notification notifying that processing is completed, and a second notification notifying that the medium is received from a preceding process to a process management apparatus,
wherein the process management apparatus comprises
a receiving unit that receives the identification information read by each of the plurality of readers provided to correspond to the plurality of processes, the first notification, and the second notification from the plurality of terminal apparatuses provided to correspond to the plurality of processes; and
a processing unit that executes predetermined processing, when the identification information read by a reader provided to correspond to a next process of an arbitrary process of the plurality of processes and the second notification are not received from a terminal apparatus provided to correspond to the next process, within a predetermined time period after the identification information read by a reader provided to correspond to the arbitrary process and the first notification are received from a terminal apparatus provided to correspond to the arbitrary process.

10. A terminal apparatus that is provided to correspond to each of a plurality of processes to receive a medium assigned with identification information and process the medium, the terminal apparatus comprising:
a transmitting unit that transmits the identification information read by each of a plurality of readers provided to correspond to the plurality of processes when the medium is received, a first notification, and a second notification to a process management apparatus,
wherein the process management apparatus comprises
a receiving unit that receives the identification information read by each of the plurality of readers provided to correspond to the plurality of processes, the first notification, and the second notification from each of the plurality of terminal apparatuses provided to correspond to the plurality of processes; and
a processing unit that executes predetermined processing, when the identification information read by a reader provided to correspond to a next process of an arbitrary process of the plurality of processes and the second notification are received from a terminal apparatus provided to correspond to the next process before the identification information read by a reader provided to correspond to the arbitrary process and the first notification are received from a terminal apparatus provided to correspond to the arbitrary process.

11. A process management system comprising:
a process management apparatus that comprises
a receiving unit that receives identification information, a first notification, and a second notification from each of a plurality of terminal apparatuses, the plurality of terminal apparatuses being provided to correspond to a plurality of processes to sequentially receive a medium assigned with the identification information and process the medium, the identification information being read by each of a plurality of readers provided to correspond to the plurality of processes when the medium is received, the first notification notifying that processing in a process where the identification information is read is completed, the second notification notifying that the medium is received from a preceding process, and
a processing unit that executes predetermined processing, when the identification information read by a reader provided to correspond to a next process of an arbitrary process of the plurality of processes and the second notification are not received from a terminal apparatus provided to correspond to the next process, within a predetermined time period after the identification information read by a reader provided to correspond to the arbitrary process and the first notification are received from a terminal apparatus provided to correspond to the arbitrary process;
the plurality of readers that are provided to correspond to the plurality of processes; and
the plurality of terminal apparatuses that are provided to correspond to the plurality of processes, and transmit the identification information read by the plurality of readers provided to correspond to the plurality processes when the medium is received, the first notification, and the second notification to the process management apparatus.

12. The process management system of claim 11, wherein the processing unit executes processing for transmitting a diagnosis request, which requests to diagnose of whether the reader provided to correspond to the next process is normal, to the terminal apparatus provided to correspond to the next process, as the predetermined processing.

13. The process management system of claim 12, wherein, when the diagnosis result of the reader executed with respect to the diagnosis request is normal and the arbitrary process is not a first process of the plurality of processes, the processing unit transmits a notification indicating that an abnormality other than an abnormality of the reader provided to correspond to the next process has occurred to at least one of a terminal apparatus provided to correspond to the first process, the terminal apparatus provided to correspond to the arbitrary process, or the terminal apparatus provided to correspond to the next process.

14. The process management system of claim 12, wherein, when the diagnosis result of the reader executed with respect to the diagnosis request is normal and the arbitrary process is a first process of the plurality of processes, the processing unit transmits a notification indicating that an abnormality other than an abnormality of the reader provided to correspond to the next process has occurred to at least one of the terminal apparatus provided to correspond to the arbitrary process or the terminal apparatus provided to correspond to the next process.

15. The process management system of claim 11, wherein the predetermined time period is determined based on at least one of a date and time or a time when the identification information and the first notification are received from the arbitrary process, a processing time necessary to process the next process, a time limit by which processing of the next process is to be completed, or a movement time of the medium according to a distance from a disposition of the reader corresponding to the arbitrary process to a disposition of the reader corresponding to the next process.

16. A process management system, comprising:
a process management apparatus that comprises
a receiving unit that receives identification information, a first notification, and a second notification from each of a plurality of terminal apparatuses, the plurality of terminal apparatuses being provided to correspond to a plurality of processes to sequentially receive a medium assigned with the identification information and process the medium, the identification information being read by each of a plurality of readers provided to correspond to the plurality of processes when the medium is received, the first notification notifying that processing in a process where the identification information is read is completed, the second notification notifying that the medium is received from a preceding process, and
a processing unit that executes predetermined processing, when the identification information read by a reader provided to correspond to a next process of an arbitrary process of the plurality of processes and the second notification are received from a terminal apparatus provided to correspond to the next process before the identification information read by a reader provided to correspond to the arbitrary process and the first notification are received from a terminal apparatus provided to correspond to the arbitrary process;
the plurality of readers that are provided to correspond to the plurality of processes; and
the plurality of terminal apparatuses that are provided to correspond to the plurality of processes, and transmit the identification information read by the plurality of readers provided to correspond to the plurality processes when the medium is received, the first notification, and the second notification to the process management apparatus.

17. A computer readable medium storing a program causing a computer to execute a process management process, the process management process comprising:
receiving identification information, a first notification, and a second notification from each of a plurality of terminal apparatuses, the plurality of terminal apparatuses being provided to correspond to a plurality of processes to sequentially receive a medium assigned with the identification information and process the medium, the identification information being read by each of a plurality of readers provided to correspond to the plurality of processes when the medium is received, the first notification notifying that processing in a process where the identification information is read is completed, the second notification notifying that the medium is received from a preceding process; and
executing predetermined processing, when the identification information read by a reader provided to correspond to a next process of an arbitrary process of the plurality of processes and the second notification are not received from a terminal apparatus provided to correspond to the next process, within a predetermined time period after the identification information read by a reader provided to correspond to the arbitrary process and the first notification are received from a terminal apparatus provided to correspond to the arbitrary process.

18. A computer readable medium storing a program causing a computer to execute a process management process, the process management process comprising:
receiving identification information, a first notification, and a second notification from each of a plurality of terminal apparatuses, the plurality of terminal apparatuses being provided to correspond to a plurality of processes to sequentially receive a medium assigned with the identification information and process the medium, the identification information being read by each of a plurality of readers provided to correspond to the plurality of processes when the medium is received, the first notification notifying that processing in a process where the identification information is read is completed, the second notification notifying that the medium is received from a preceding process; and
executing predetermined processing, when the identification information read by a reader provided to correspond to a next process of an arbitrary process of the plurality of processes and the second notification are received from a terminal apparatus provided to correspond to the next process before the identification information read by a reader provided to correspond to the arbitrary process and the first notification are received from a terminal apparatus provided to correspond to the arbitrary process.

19. A process management method, comprising:
receiving identification information, a first notification, and a second notification from each of a plurality of terminal apparatuses, the plurality of terminal apparatuses being provided to correspond to a plurality of processes to sequentially receive a medium assigned with the identification information and process the medium, the identification information being read by each of a plurality of readers provided to correspond to the plurality of processes when the medium is received, the first notification notifying that processing in a process where the identification information is read is completed, the second notification notifying that the medium is received from a preceding process; and
executing predetermined processing, when the identification information read by a reader provided to correspond to a next process of an arbitrary process of the plurality of processes and the second notification are not received from a terminal apparatus provided to correspond to the next process, within a predetermined time period after the identification information read by a reader provided to correspond to the arbitrary process and the first notification are received from a terminal apparatus provided to correspond to the arbitrary process.
